(19) United States
(12) Patent Application Publication
(10) Pub. No.: US 2003/0210233 A1
(43) Pub. Date: Nov. 13, 2003

(54) Computer user interface input device and a method of using same

(75) Inventor: Roberto E. Frulla, Temecula, CA (US)

Correspondence Address: FOLEY & LARDNER, 402 WEST BROADWAY, 23RD FLOOR, SAN DIEGO, CA, 92101

(73) Assignee: Touch Controls, Inc.

(21) Appl. No.: 10/144,913

(22) Filed: May 13, 2002

(51) Int. Cl. G09G 5/00

(52) U.S. Cl. 345/168

(57) ABSTRACT

An example of the present invention as disclosed herein provides an improved user interface input device that enables a person to slide his or her digit or other indicator over a surface between a neutral and a discrete touch sensor position. Sliding a digit such as a finger requires much less concentration and precision of movement as compared to lifting and lowering a finger when activating a conventional key, and thus is characterized by ease of operation. Motion and speed selection for the user interface starts only after the finger is moved over the discrete touch sensors, and hence the mental and muscular coordination strain felt by users of a conventional mouse or other user interface input device is minimized or greatly reduced.

### BACKGROUND OF THE INVENTION

1. Field of the Invention

The present invention relates in general to a computer user interface input device and a method of using it. It more particularly relates to such an input device and a method for manipulating a user interface in a facile, precise manner.

2. Related Art

The information contained in this section relates to the background of the art of the present invention without any admission as to whether or not it legally constitutes prior art.

Graphical user interfaces have been employed in connection with computers to facilitate the operation and function of the software employed by the computer. For example, reference may be made to the following U.S. patents, each of which being incorporated herein by reference:

| PATENT NO. | INVENTOR | ISSUE DATE |
|---|---|---|
| 5,049,863 | Oka | Sep. 17, 1991 |
| 5,577,848 | Bowen | Nov. 26, 1996 |
| 5,600,313 | Freedman | Feb. 04, 1997 |
| 5,621,436 | Solhjell | Apr. 15, 1997 |
| 5,982,302 | Ure | Nov. 09, 1999 |
| 6,072,482 | Moon, et al. | Jun. 06, 2000 |
| 6,100,875 | Goodman, et al. | Aug. 08, 2000 |
| 6,107,997 | Ure | Aug. 22, 2000 |
| 6,213,880 B1 | Sim | Apr. 10, 2001 |

One popular graphical user interface input device currently in use is a mouse which is operated by moving it relative to a surface to control a mouse arrow or pointer generated by the graphical user interface software of a computer. Selection keys such as left click and right click keys are included with the mouse to execute software functions.

Such graphical user input devices have also been incorporated into keyboards for a computer. For example, touch pads have been incorporated in keyboards for laptop and notebook computers. Such touch pads are activated by the finger of the operator sliding along the surface thereof to direct the motion of the mouse arrow. The mouse arrow moves at a speed and in a direction corresponding to the relative movement of the operator's finger until the finger is raised from engagement with the touch pad surface. Such an operation is satisfactory for some applications, but it is sometimes difficult or awkward to use when attempting to guide the movement of the mouse arrow in a desired direction. In this regard, the arrow movement is not always very precise. Unwanted or unintended movements of the mouse arrow sometimes result, and thus it is sometimes difficult to precisely and accurately position the mouse arrow to cause the execution of a software function..

In order to have a mouse input device forming a part of a keyboard, a system disclosed in the aforementioned U.S. Pat. No. 6,100,875 utilizes the arrow keys of the keyboard to perform a dual function. The arrow keys perform their normal function of moving a cursor. Additionally, when a function key is pressed, the arrow keys then provide the alternative function to control the mouse arrow movement. However, such an arrangement provides for only limited movement of the mouse arrow in the four directions of the arrow keys. Also, the patented technique does require repetitive motions of the fingers moving up and down and shifting between the four arrow keys. Therefore, it would be highly desirable to have a user interface input device which may be incorporated in a computer keyboard or other electronic device, as well as being used as a separate input device, and which enables precise control and movement of user interface functions in an ergonomically desirable manner.

### BRIEF DESCRIPTION OF THE DRAWINGS

In the following, the invention will be explained in further detail with reference to the drawings, in which:

FIG. 1 is a face view of a user interface input device, which is constructed in accordance with one example of the present invention, and which is incorporated in a computer keyboard;

FIG. 2 is a block diagram of a circuit of the device of FIG. 1;

FIG. 3 is a flow chart diagram of an example of a method of using the device of FIG. 2;

FIG. 4 is a face view of a portion of a position indicating device, which is also constructed in accordance with another example of the present invention;

FIG. 5 is a face view of a portion of a position indicating device, which is also constructed in accordance with yet another example of the present invention;

FIG. 6 is a face view of a portion of a position indicating device, which is also constructed in accordance with a further example of the present invention;

FIG. 7 is a face view of a portion of a position indicating device, which is also constructed in accordance with yet another example of the present invention;

FIG. 8 is a face view of a portion of a position indicating device, which is also constructed in accordance with still another example of the present invention; and

FIG. 9 is a face view of a user interface device, which is constructed in accordance with a further example of the present invention, and which is incorporated in a computer keyboard.

### DESCRIPTION OF CERTAIN EMBODIMENTS OF THE INVENTION

An example of the present invention as disclosed herein provides an improved user interface input device that enables a person to slide his or her digit or other indicator over a surface between a neutral and a discrete touch sensor position. Sliding a digit such as a finger requires much less concentration and precision of movement as compared to lifting and lowering a finger when activating a conventional key, and thus is characterized by ease of operation. Motion and speed selection for the user interface starts only after the finger is moved over the discrete touch sensors, and hence the mental and muscular coordination strain felt by users of a conventional mouse or other user interface input device is minimized or greatly reduced.

In another aspect of the disclosed embodiment of the present invention, diagonal movement sensors are provided for greater precision in guiding the mouse arrow. In a further aspect of the disclosed invention, speed adjustment touch sensors are provided for controlling the speed of the movement of the mouse arrow or other user interface indicator.

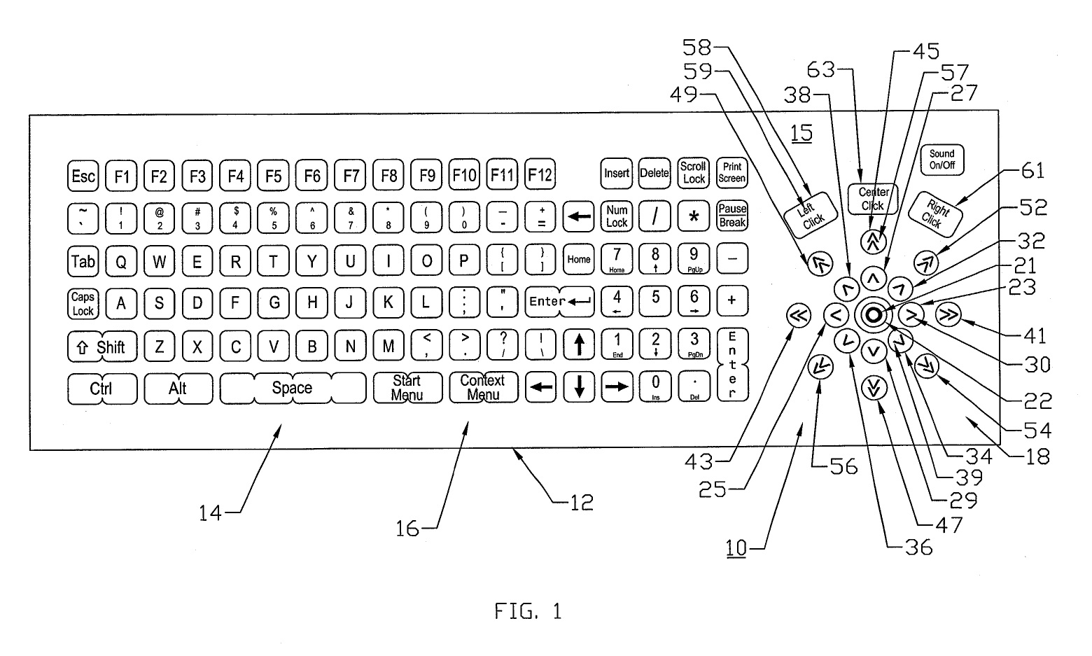

Referring now to the drawings, and more particularly to FIG. 1 thereof, there is shown a user interface device 10, which is constructed in accordance with a preferred embodiment of the present invention. The device 10 is incorporated in a computer keyboard 12 which has a substantially flat panel or member 14. On a substantially flat exterior upper surface 15 of the panel 14 there is disposed a group of character and function key positions 16 arranged as incorporated in a conventional keyboard configuration for use with a computer processor unit (not shown) and a monitor (not shown). It will become apparent to those skilled in the art, that the input device of the present invention may also be incorporated in other computers such as laptop and notebook computers and personal digital assistants as well as others. For explanation purposes, the disclosed example of the present invention will be described as a user interface input device for controlling conventional mouse functions of a graphical user interface for a computer, but it is to be understood that the scope of the invention should not be limited to this specific application only.

The input device 10 generally comprises a plurality of touch sensors 18 which are arranged relative to a centrally disposed neutral or rest position 21 having neutral indicia 22 thereon for designating the area for engagement by a digit of the operator. The plurality of touch sensors 18 include four horizontal and vertical direction touch sensors, comprising a right direction sensor 23, a left direction sensor 25, an up direction sensor 27 and a down direction sensor 29 arranged in a diamond configuration surrounding the centrally disposed neutral position 21 and having thereon direction indicia such as a right arrow direction indicia 30. When the user slides his or her finger from the neutral position 21 radially outwardly relative thereto in engagement with the external surface 15 of the panel 14, or otherwise engages one of the direction sensors such as the right direction sensor 23, the mouse arrow is caused to move rightwardly at a substantially constant rate of speed in a rightward direction. The mouse arrow continues to move rightwardly, until the finger is raised or slid back to the neutral position 21.

A set of four diagonal direction sensors, comprising sensors 32, 34, 36, and 38 are spaced from, and are interleaved with, the horizontal and vertical direction sensors to provide for directing a mouse arrow in multiple diagonal directions. The diagonal direction sensors have diagonal direction indicia such as an arrow indicia 39 thereon. It will become apparent to those skilled in the art that additional diagonal sensors (not shown) may also be employed such that there can be more than one diagonal sensor disposed between adjacent ones of the horizontal and vertical sensors to provide for a more precise and convenient control over the mouse arrow. When the finger of the user is slid from the neutral position 21 to one of the diagonal sensors, the mouse arrow is caused to move in the indicated diagonal direction in a similar manner as the operation of the direction sensors.

In order to provide for the change of speed of the movement of the mouse arrow, a set of eight speed adjustment sensors 41, 43, 45, 47, 49, 52, 54, and 56 correspond to the horizontal, vertical, and diagonal direction sensors and are disposed radially outwardly therefrom relative to the neutral position 21. Each speed adjustment sensor such as the sensor 45 bears on its face an indicia such as a double arrow indicia 57. By sliding the finger of the user radially outwardly in a straight line from a direction sensor such as the sensor right sensor 23 to the speed adjustment sensor such as the sensor 41, the speed of the movement of the mouse arrow is increased incrementally in the same rightward direction. When the finger movement is slid back to the sensor 23, the speed of movement of the mouse arrow decrements to its initial speed, while it continues in the rightward direction.

Additionally, there are three selection sensors disposed adjacent to one another and above the direction sensors and comprise a right click selection sensor 61, a center click selection sensor 63, and a left click selection sensor 58 to cause the execution of the corresponding mouse functions. The selection sensors each have selection indicia thereon such as left click selection indicia 59.

In one example of the use of the input device 10, the input device 10 is activated by an operator by interacting with one of the discrete touch sensors to generate a signal indicative of a user interface function. More specifically, a person touches one of the horizontal and vertical direction sensors such as the right direction sensor 23 by either sliding the finger from the neutral position 21 or otherwise moving the finger directly to the sensor 23 to generate a signal, as hereinafter described in greater detail, to cause a mouse arrow to move rightwardly.

The operator may then choose to increase the speed of the movement of the mouse arrow, and then slides his or her finger from the sensor 23 to the adjacent speed adjustment sensor 41 substantially within the plane of the sensors to cause the mouse arrow speed to increase incrementally by generating a suitable signal. When it is desired to stop the rightward movement, the operator slides his or her finger toward the neutral position 21 substantially within the plane of the sensors along the surface 15 to terminate the signal and thus stop the movement of the mouse arrow. Alternatively, the operator may lift the finger from the sensor 23 to terminate the signal. Thereafter, the operator rests his or her finger on the neutral position to then become ready to commence interactions with the other direction sensors.

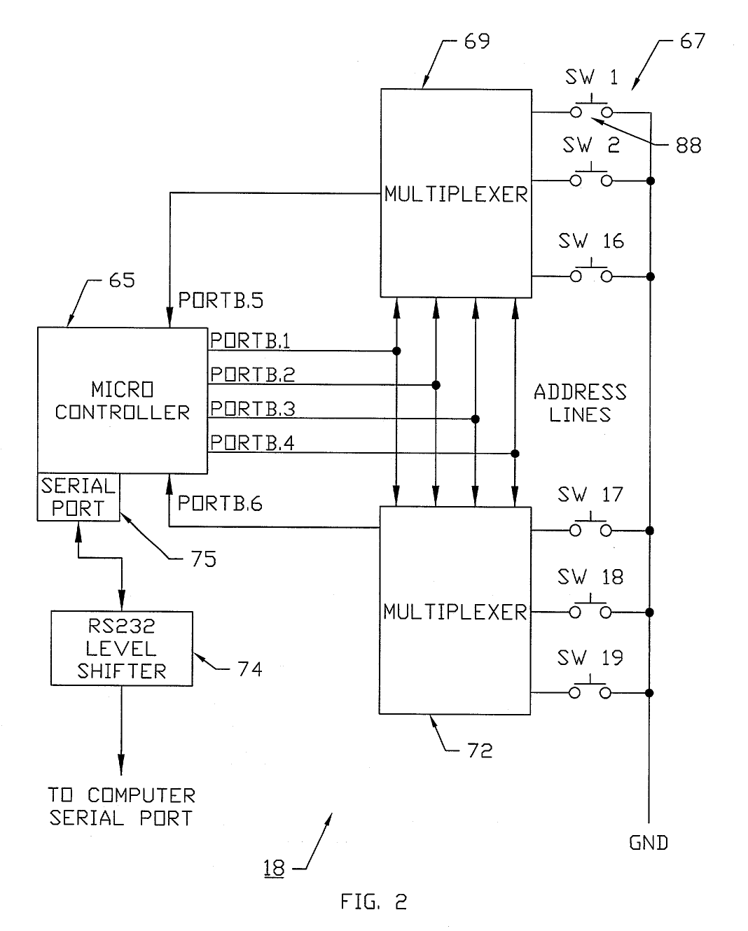

Considering now the sensors in greater detail, the flat panel 14 may be composed of a substantially rigid material such as stainless steel, glass, ceramic or other suitable materials. The sensors such as the sensor 23 generally comprise positions or portions of the panel 14, and a set of switches generally indicated at 67 (FIG. 2) disposed behind the panel 14. In the preferred embodiment of the present invention, the set of switches 67 is a set of sheer acoustic switches disposed behind the panel 14 opposite, and in registration with the corresponding sensor positions of the panel 14, whereby the engagement of an object such as a digit of the operator with the front external surface 15 of the panel cause the switch to generate an electrical signal to activate the graphical user interface of a computer processor unit (not shown).

It should be understood that other types of sensors may also be employed in accordance with the present invention. In this regard, conventional mechanically moveable keys, capacitive switches behind a plate or panel, a touch screen, projected touch sensitive techniques, or other devices may be employed for causing the generation of electrical signals upon interaction therewith by the operator.

Referring now to FIG. 2, there is shown a microcontroller 65 of the input device 18 which receives signals or inputs from the switches generally indicated at 67 via a pair of multiplexers 69 and 72 to respond to individual ones of the switch closures of the switch 67 forming parts of the sensors shown in FIG. 1. A level shifter 74 responds to a serial port 75 of the microcontroller 65 to provide a serial pulse stream in a mouse format to a computer serial port (not shown) of a computer processor unit (not shown). In this regard, the microcontroller 65 converts the switch inputs from the switches 67 to a serial pulse stream in a mouse format. Thus when the finger of the user is over one of the sensors shown in FIG. 1, a mouse arrow displayed on a monitor (not shown) moves in that direction at a preset speed. While the preset speed can be adjusted, a slow movement in one direction is achieved when the finger is close to the neutral position by touching one of the direction sensors and in a fast movement in one direction when the finger is disposed remotely from the neutral position over a speed adjustment sensor. The movement of the cursor arrow stops when the finger is lifted. The rate of movement changes when the finger is slid from the fast to the slow position, or the direction stops when the finger is slid to the center or neutral position, which is an inactive position where no switches are present.

The mouse function activation (left, right or center clicks) is achieved by placing the finger over the appropriate placed switches to generate corresponding signals which are received by the microcontroller 65. Beeps or clicking sounds can be generated when the sensors are touched.

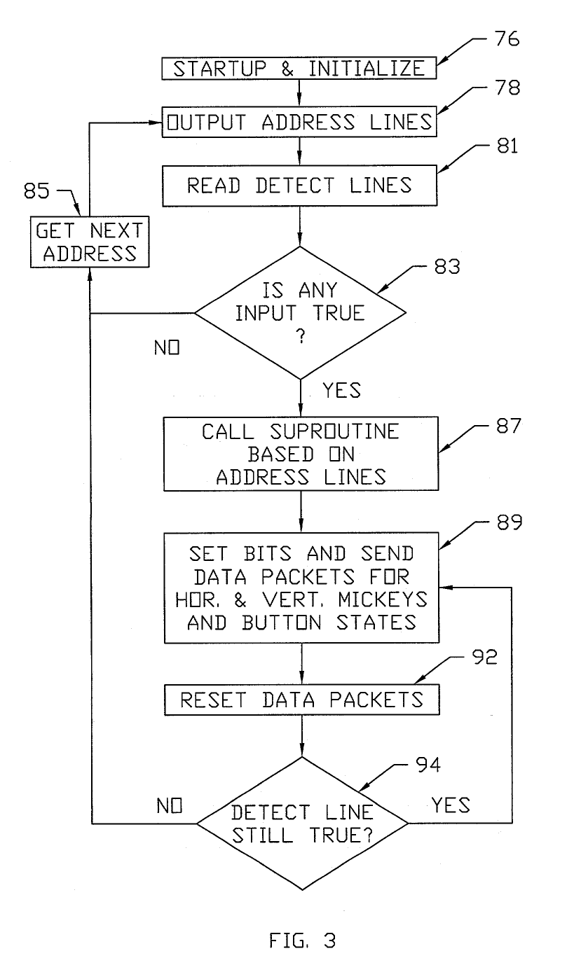

Referring now to FIG. 3, there is shown a method of operation of the device 10 of FIG. 1. The method shown in FIG. 3 is a specific example of a preferred form of the present invention relating to the firmware of the microprocessor 65. The method commences at a start up and initialization box 76. At a box 78, the microcontroller 65 addresses output address lines from the multiplexers 69 and 72. At box 81, the microcontroller 65 reads the detected lines.

At the decision box 83, the microcontroller 65 determines whether or not any of the inputs are true. If none of them are true, it is indicated at box 85, the microcontroller 65 obtains the next address and loops back to the box 78. If it is determined at the decision box 83 that one of the inputs is true, then the firmware transitions to a box 87 to call a subroutine based on the address lines. For example, a right direction sensor 23 (FIG. 1) being touched by a digit of the user may cause one of the switches 67 such as a switch 88 of the right direction sensor 23 to be true so that this information can be converted to a serial pulse stream in a mouse format indicating the right direction sensor 23 being engaged.

Thereafter, as indicated at box 89, bits are set and data packets are sent for horizontal and vertical mickeys and button states. Thereafter, at box 92, the data packets are reset and the firmware transitions to a decision box 94 to detect whether or not the line still remains true.

If the line remains true such as the finger of the user engaging the right direction sensor 23, the firmware transitions back to box 89 to continue the cycle of operation until the line is no longer true. Thereafter, the firmware transitions from the box 94 to the box 85 to obtain the next address.

The following is a more detailed explanation of the firmware of the microcontroller 65 to execute the method of FIG. 3.

Start Up and Initialize:

The mouse emulator first includes a BASIC definition file for serial data communication then declares variables, sets the interrupt vector, and establishes port I/O functions.

Start Up and Initialize:

Three 8-bit variable arrays are declared: FP_MouseOut, SP_MouseOut, and TP_MouseOut. First, second and third mouse data packets to be transmitted to the host computer's COM port.

Start Up and Initialize:

The interrupt enables the mouse emulator to identify itself as a mouse to the host computer upon powering on the computer. The interrupt is called when the host computer toggles the RTS line. The interrupt is triggered on the falling edge of the RTS line. When called, the interrupt routine transmits the letter “M”, (ADCII 77) to the host computer. The serial data is transmitted at 1200 baud, 1 stop bit, no parity, and no flow control out PORTB.7. The data is sent in its true state, not inverted.

Start Up and Initialize:

The microprocessor address lines, PORTB.1 through PORTB.4, are initialized to a low logic level. A subroutine, Mouse Reset, is called to set the mouse data packets to a known, static condition. For example, the mouse is not moving and there are no mouse buttons pressed.

The main part of the program is then called.

Output Address Lines:

The address lines are incremented from binary 0, to binary 15. After each increment, the program pauses for 10 milliseconds.

Read Detect Lines:

The state of the input ports, PORTB.5 and PORTB.6, are then interrogated.

Either Input Line True?:

If the state of the input port is a logic level high, then the program calls a unique subroutine that reflects that address.

Set Data Bits and Send:

The subroutine sets the bits in one or more of the mouse data packets, FP_MouseOut, SP_MouseOut, and TP_MouseOut. Once the bits are set, the subroutine then calls a second subroutine, RackEm, which accumulates the bits in each data packet and sends them serially to the host computer. After the data has been sent, the RackEm subroutine returns to the unique calling subroutine where the MouseReset subroutine is called.

Detect Lines Still True?:

As long as the input port state is a logic level high, the subroutine maintains the focus of the program. The bits are set again and transmitted to the host computer. Once the input port returns to a low logic level, the program leaves the unique subroutine and returns to the location in the main program from which it was called.

The address lines are then incremented and the input ports are interrogated again.

The microprocessor used is Microchip's 16F873-04/SP. The program is complied and assembled using Micro Engineering's compiler and assembler for the PIC micro controller.

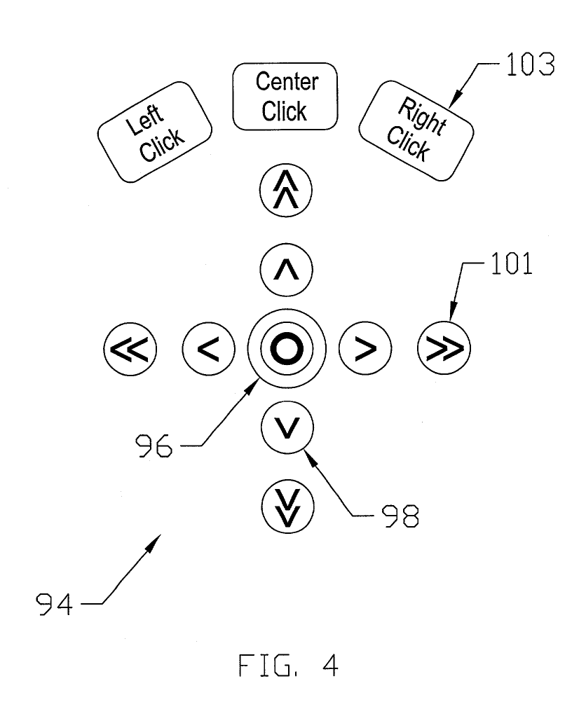

Referring now to FIG. 4, there is shown a user interface input device 94, which is constructed in accordance with another example of the present invention, and which is similar to the device 10 of FIG. 1 except that diagonally arranged speed sensors are omitted. The device 94 includes a neutral or rest position 96 centrally disposed relative to a diamond configuration of horizontal and vertical direction sensors generally indicated at 98 which are similar to the horizontal and vertical sensors of FIG. 1. A set of four speed adjustment sensors 101 are disposed adjacent to corresponding ones of the direction sensors and are spaced outwardly from the neutral position 96 so that a finger of the user can be slid from the neutral position 96 in a straight line to a desired direction sensor to commence the movement of the mouse arrow. The finger can then be moved to the speed adjustment sensor 101 to cause a faster speed of movement of the mouse arrow in the same direction. The movement continues until the finger is slid back to the neutral position 96 or lifted away from the speed adjustment sensor 101, to prevent further movement of the mouse arrow.

A set of three selection sensors such as a right click selection sensor 103 are positioned in close proximity to such other in a similar manner as the selection sensors are positioned in the device 10.

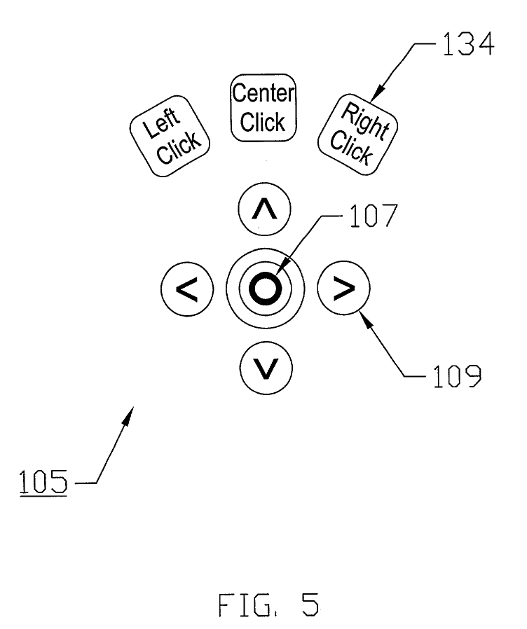

Referring now to FIG. 5, there is shown a user interface input device 105, which is constructed in accordance with yet another example of the present invention, and which is similar to the device 10 of FIG. 1 except that the speed adjustment sensors and diagonal direction sensors have been omitted. The device 105 includes a neutral or rest position 107 centrally disposed relative to a diamond configuration of horizontal and vertical direction sensors such as the right direction sensor 109 which is similar to the right direction sensor of FIG. 1. A set of three selection sensors such as a right click selection sensor 134 are positioned in close proximity to each other in a similar manner as the selection sensors are positioned in the device 10.

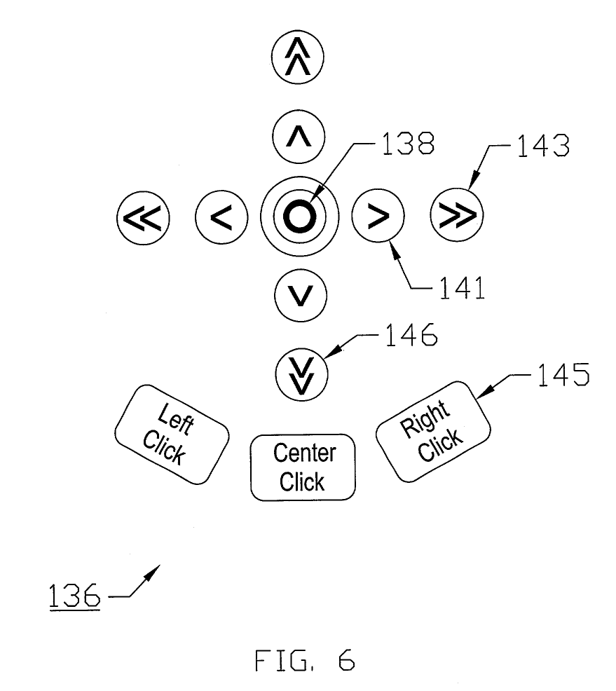

Referring now to FIG. 6, there is shown a user interface input device 136, which is constructed in accordance with yet another example of the present invention, and which is similar to the device 10 of FIG. 1 except that the diagonal direction sensors in the diagonal speed adjustment sensors have been omitted, with the selection sensors being disposed at the bottom portion of the input device. The device 136 includes a neutral or rest position 138 centrally disposed relative to a diamond configuration of horizontal and vertical direction sensors such as a right direction sensor 141 which is similar to the right direction sensor of FIG. 1. A set of four speed adjustment sensors such as a speed adjustment sensor 143 are disposed adjacent to corresponding ones of the direction sensors and are spaced outwardly from the neutral position 138 so that a finger of the user can be slid from the neutral position 138 in a straight line in the plane of the sensors to a desired direction sensor to commence the movement of the mouse arrow. The finger can then be moved to the speed adjustment sensor 143 to cause a faster speed of movement of the mouse arrow in the same direction. The movement continues until the finger is slid back to the neutral position 138 or lifted away from the speed sensor 143, to prevent further movement of the mouse arrow.

A set of three selection sensors such as a right click selection sensor 145 are positioned in close proximity to each other and is disposed below and adjacent to a speed adjustment down direction sensor 146.

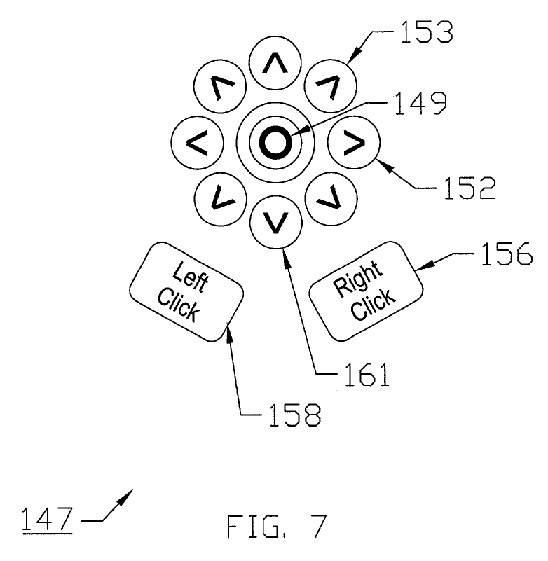

Referring now to FIG. 7, there is shown a user interface input device 147, which is constructed in accordance with still a further example of the present invention, and which is similar to the device 10 of FIG. 1 except that all of the speed adjustment sensors have been omitted and only two of the selection sensors are included spaced from and adjacent to a down direction sensor. The device 147 includes a neutral or rest position 149 centrally disposed relative to a diamond configuration of horizontal and vertical direction sensors such as a right direction sensor 152 which are similar to the horizontal and vertical sensors of FIG. 1. A set of four diagonal direction sensors such as a diagonal direction sensor 153 interleaved with the horizontal and vertical direction sensors in a similar is shown in FIG. 1.

The input device 147 includes only two selection sensors, a right click selection sensor 156 and a left click selection sensor 158, disposed in a generally V-shaped configuration spaced from and adjacent to a down direction sensor 161 of the horizontal and vertical direction sensors. +

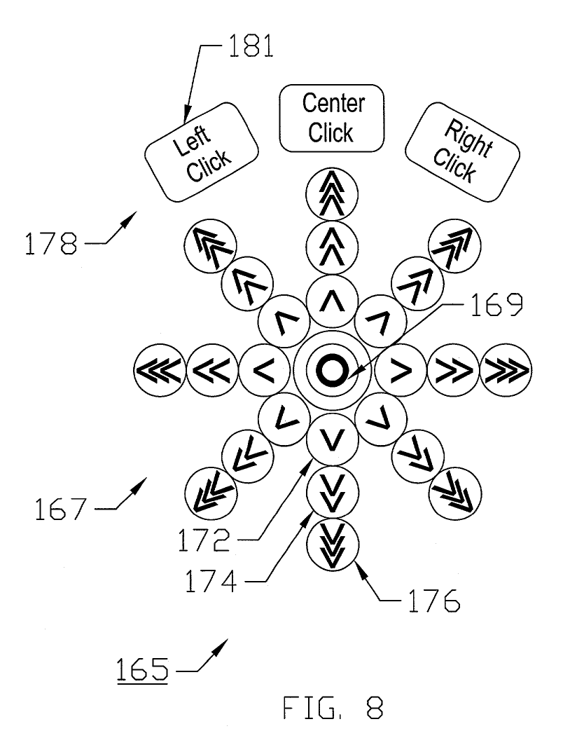

Referring now to FIG. 8, there is shown a user interface input device 165, which is constructed in accordance with yet another example of the present invention, and which is similar to the device 10 of FIG. 1 except that there are an additional set of speed adjustment sensors. The device 165 includes a plurality of touch sensors generally indicated at 167, which include a neutral position 169, and a set of eight concentrically positioned, circularly configured low speed direction sensors, such as a low speed direction sensor 172 indicating a down movement. Additionally, a set of eight circularly configured corresponding intermediate speed direction sensors, such as an intermediate speed direction sensor 174 disposed opposite the low speed direction sensor 172, provide a similar function as the increased speed sensors such as the sensor 52 of the device 10 of FIG. 1. A set of eight circularly configured high speed direction sensors, such as a high speed direction sensor 176 are disposed concentrically outwardly relative to the intermediate speed sensors to provide a still higher speed of movement of the mouse arrow.

The low speed direction sensors, the intermediate direction sensors and the high speed direction sensors are arranged concentrically with corresponding sensors, such as the sensors 172, 174 and 176, being arranged contiguously and in a straight radial line relative to the neutral position 169. In this manner, the user can readily slide his or her digit between the aligned low, intermediate and high speed direction sensors in a convenient manner to adjust the speed of the mouse arrow accordingly.

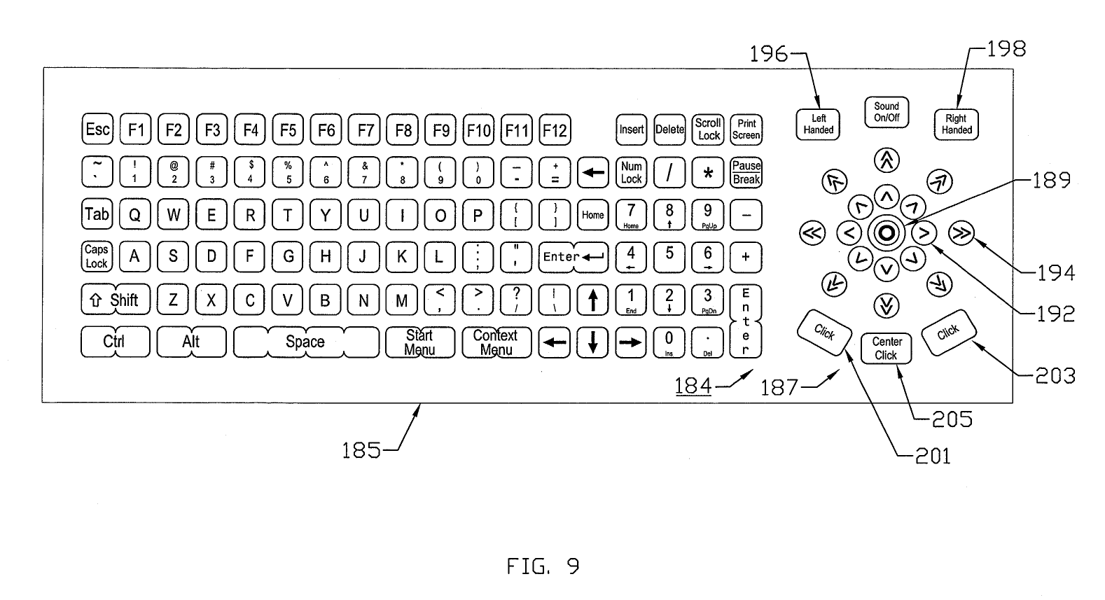

Referring now to FIG. 9, there is shown a user interface device 184, which is constructed in accordance with a preferred embodiment of the present invention, and which is incorporated in a computer keyboard 185. The device 184 is similar is similar to the device 10, except that the device 184 accommodates right and left handed users relative to the use of primary and secondary click selection sensors.

The device 184 includes a plurality of touch sensors generally indicated at 187. A neutral position 189 is surrounded by a circular configuration of eight direction sensors such as a right direction sensor 192. A set of eight increased speed sensors 194, such as a right increased speed sensor 194 disposed radially outwardly from the sensor 192, to enable the user to slide his or her digit between the inner direction sensors to the increased speed sensors for speed adjustment purposes for the mouse arrow.

A left handed 196 and a right handed sensor 198 are disposed above the increased speed sensors to enable a user to select either a left handed or a right handed configuration relative to a pair of click sensors 201 and 203 flanking a center click sensor 205 disposed below the increased speed sensors. In this regard, a person can select the button desired to be used for most tasks by activating either the left handed sensor 196 or the right handed sensor 198.

In use, should the right handed sensor 198 be activated by touching it with the digit of the user, then the primary and secondary click functions will be controlled by the click sensors 201 and 203 depending upon the software commands utilized. Alternatively, should the user select the left handed sensor 196 and activate it, then the software causes the functions to be toggled relative to the click sensors 201 and 203 as compared to their functioning when the right handed sensor 198 is selected. Thus, a given user can select whichever one of the two click sensors 201 and 203 to perform the primary click functions by activating either the left handed sensor 196 or the right handed sensor 198.

While particular embodiments of the present invention have been disclosed, it is to be understood that various different modifications are possible and are contemplated within the true spirit and scope of the appended claims. There is no intention, therefore, of limitations to the exact abstract or disclosure herein presented.

What is claimed is:

1. A user interface input device for a user interface for a computer, comprising: a member having a substantially flat exterior surface on the front side thereof;
a plurality of discrete touch sensors arranged in a spaced apart manner on said member for sensing the touch of an operator and generating a signal indicative of a feature related to the user interface;
each one of said touch sensors having user interface function indicia disposed on the front side of said surface; and
a neutral position on the front side of said surface centrally disposed relative to said sensors for not generating a signal relating to the user interface when a digit of the operator is slid from one of said sensors to said neutral position.

2. A device according to claim 1, wherein said member includes a substantially flat panel, and said sensors are each mounted behind said panel.

3. A device according to claim 1, wherein said sensors are arranged in a generally diamond shaped configuration, said neutral position being disposed substantially centrally, within said diamond shaped configuration.

4. A device according to claim 3, wherein said sensors include four horizontal and vertical direction sensors arranged in said diamond shaped configuration to provide horizontal and vertical direction input information to cause a mouse pointer to move along a desired direction, and a group of diagonal direction sensors arranged interleaved with said horizontal and vertical sensors in a spaced-apart manner to provide diagonal direction input information to cause a mouse pointer to move along a desired direction.

5. A device according to claim 4, wherein said sensors include a group of speed adjustment sensors disposed adjacent to said direction sensors for changing the speed of the movement of a mouse pointer.

6. A device according to claim 5, wherein said speed adjustment sensors are intermediate speed sensors, and further including a group of high speed sensors disposed adjacent to said intermediate speed sensors.

7. A device according to claim 5, wherein said sensors further includes a plurality of selection sensors.

8. A device according to claim 7, wherein said selection sensors include a pair of click sensors and right and left handed sensor means for assigning primary and secondary click functions to the individual ones of said pair of click sensors.

9. A user interface input device for a user interface for a computer, comprising:
a member having a surface; and
at least five discrete touch sensors arranged in a spaced apart manner on said member for sensing the touch of an operator and generating a signal indicative of a direction feature related to the user interface, wherein four of said touch sensors being useful in generating signals relating to vertical and horizontal user interface movements and at least one additional sensor useful in generating signals relating to diagonal user interface movements.

10. A device according to claim 9, wherein said member includes a substantially flat panel, and said sensors are each mounted behind said panel.

11. A device according to claim 9, wherein said sensors are arranged in a generally diamond shaped configuration, said neutral position being disposed substantially centrally, within said diamond shaped configuration.

12. A device according to claim 11, wherein said sensors include four horizontal and vertical direction sensors arranged in said diamond shaped configuration to provide horizontal and vertical direction input information to cause a mouse pointer to move along a desired direction, and a group of diagonal direction sensors arranged interleaved with said horizontal and vertical sensors in a spaced-apart manner to provide diagonal direction input information to cause a mouse pointer to move along a desired direction.

13. A device according to claim 12, wherein said sensors include a group of speed adjustment sensors disposed adjacent to said direction sensors for changing the speed of the movement of a mouse pointer.

14. A device according to claim 13, wherein said sensors further includes a plurality of selection sensors.

15. A method of using a user interface input device for a user interface for a computer, comprising:
using the input device having a plurality of discrete touch sensors and a neutral position disposed substantially in a common plane;
interacting with one of the discrete touch sensors to generate a signal indicative of a user interface function;
ceasing the interaction with the discrete sensor by moving toward the neutral position substantially within said plane to terminate the signal; and interacting with the neutral position for rest purposes.

16. A method according to claim 15, wherein said sensors are direction sensors arranged in a generally diamond shaped configuration and said neutral position is centrally disposed therewithin; and wherein said interacting includes sliding a digit of an operator within said common plane between sensors and the neutral position to generate signals indicative of mouse pointer movement directions.

17. A method according to claim 16, wherein said signals include horizontal, vertical and diagonal direction signals.

18. A method according to claim 17, further including sliding a digit of an operator between the direction sensors and speed adjustment sensors to generate signals indicative of mouse pointer speed adjustment.

19. A system including a user interface input device for a user interface, comprising:
a microprocessor;
a member having a substantially flat exterior surface on the front side thereof; a plurality of discrete touch sensors arranged in a spaced apart manner on said member for sensing the touch of an operator and generating a signal indicative of a feature related to the user interface;
each one of said touch sensors having user interface function indicia disposed on the front side of said surface; and
a neutral position on the front side of said surface centrally disposed relative to said sensors for not generating a signal relating to the user interface when a digit of the operator is slid from one of said sensors to said neutral position.

20. A system according to claim 19, wherein said member includes a substantially flat panel, and said sensors are each mounted behind said panel.

21. A system according to claim 19, wherein said system is a computer.

22. A method of using a user interface input device, comprising:
reading output address lines, corresponding to horizontal and vertical directions of movement of a mouse pointer;
determining whether any one of the lines is true;
calling a subroutine corresponding to the line determined to be true; and
generating corresponding data packets to cause mouse pointer movement.
